(19) United States
(12) Patent Application Publication
(10) Pub. No.: US 2024/0391808 A1
(43) Pub. Date: Nov. 28, 2024

(54) System and Method for Removing Contaminants From Wastewater Streams

(71) Applicant: XYLEM WATER SOLUTIONS U.S.A., INC., Brown Deer, WI (US)

(72) Inventor: Darren Paul Lawrence, Rugby (GB)

(21) Appl. No.: 18/695,883

(22) PCT Filed: Sep. 27, 2022
(86) PCT No.: PCT/US22/44793

§ 371 Date: Mar. 27, 2024

Related U.S. Application Data
(60) Provisional application No. 63/249,053, filed on Sep. 28, 2021.

(51) Int. Cl. C02F 3/06; C02F 3/08; C02F 3/10

(52) U.S. Cl. CPC C02F 3/06; C02F 3/08; C02F 3/108

(57) ABSTRACT

A wastewater treatment method provides a bioreactor including: an inlet zone, a filtration zone, and a reaction zone including: a biofilm supporting media including a biofilm of bacteria thereon. The supporting media is sufficient to enable the bacteria thereon to consume contaminants from the wastewater to produce water with a total suspended solids of less than 5 g/L and water including suspended bacteria. Wastewater is introduced to the inlet zone of the bioreactor. Anoxic and/or aerobic conditions are provided in the reaction zone to cause the consumption of the contaminants by the bacteria on the supporting media and the suspended bacteria contained in the water to produce filterable water. This water is filtered at the filtration zone to produce a filtrate and a sludge, the filtrate having a total suspended solids of less than 10 mg/L with a flowrate of at least 2,000 L/h/m² of filter area.

### CROSS REFERENCE TO RELATED APPLICATIONS

This application claims priority to U.S. Provisional Patent Application No. 63/249,053, filed Sep. 28, 2021, the disclosure of which is hereby incorporated by reference in its entirety.

### BACKGROUND OF THE INVENTION

### Field of the Invention

The present invention relates to wastewater, and particularly to systems and methods for removing contaminants from wastewater.

### Description of Related Art

Wastewater and/or sewage treatment is considered an energy intensive process and is associated with high emissions. Standard wastewater treatment plants (WWTP) or sewage treatment plants (STP) have anywhere from 10 to 25 separate unit operations, that can include over 10 process vessels or tanks that perform various filtering and/or biological processes. Examples of existing wastewater and/or sewage treatment plants known in the art are shown in FIGS. 1A and 1B. These wastewater and/or sewage treatment plants commonly include a filter 4 and various tanks comprising treatment zones 2, 3, 6 that treat wastewater to produce filterable water to be filtered by the filter 4. Existing wastewater and/or sewage treatment plants can only treat wastewater to produce filterable water having a total suspended solids content of greater than 12 g/L. As a result of the high total suspended solids content in the filterable water, a flow rate of at least 2,000 L/h per m² of filter area cannot be achieved.

### SUMMARY OF THE INVENTION

In view of the foregoing, a system and/or process for removing contaminants from wastewater to produce filterable water having less than 5 g/L total suspended solids and a flowrate of at least 2.000 L/h per m² of filter area is desired.

In one non-limiting example of the present invention, a method for removing contaminants from wastewater to produce a filtrate and a sludge includes the steps of providing a bioreactor including: an inlet zone for receiving wastewater, a filtration zone including a filter; and a reaction zone between the inlet zone and the filtration zone including: a biofilm supporting media including a biofilm of biofilm forming bacteria thereon, where the biofilm supporting media is provided in a sufficient quantity to enable the biofilm forming bacteria thereon to consume at least a portion of the contaminants from the wastewater to produce filterable water that has a total suspended solids of less than 5 g/L at the filtration zone; and water including suspended bacteria; and introducing wastewater including contaminants to the inlet zone of the bioreactor; providing anoxic and/or aerobic conditions in the reaction zone of the bioreactor to cause the consumption of the contaminants by the biofilm forming bacteria on the biofilm supporting media and the suspended bacteria contained in the water to produce filterable water; and filtering the filterable water at the filtration zone to produce a filtrate and a sludge, where the filtrate has total suspended solids of less than 10 mg/L with a flowrate of at least 2,000 L/h per m² of filter area.

The biofilm forming bacteria may consumes at least 75% by mass of the contaminants. The method may further include transferring the filtrate external of the bioreactor. The method may further include transferring at least a portion of the sludge external of the bioreactor. The method may further include transferring at least a portion of the sludge to the inlet zone. The transferring at least a portion of the sludge to the inlet zone step may include pumping the sludge to the inlet zone. The transferring at least a portion of the sludge to the inlet zone step may further include actively mixing the sludge with the wastewater and/or filterable water in a transfer pipe. The method may further include aerating the water in the reaction zone such that the water includes less than 5,000 mg/L of total suspended solids. The method may further include discharging excess biofilm forming bacteria on the biofilm supporting media into the water. The method may further include aerating the biofilm supporting media to discharge excess biofilm forming bacteria on the biofilm supporting media into the water. The bioreactor may include a single tank including the inlet zone, the reaction zone, and the filtration zone. The bioreactor may include a plurality of tanks that are interconnected. The plurality of tanks may include a first tank including the inlet zone, a second tank including the reaction zone, and a third tank including the filtration zone. The filtrate may have a flow rate of at least 3,000 L/h per m² of filter area. The bioreactor may include a plurality of biofilm supporting media. The inlet zone, filtration zone, and/or the reaction zone of the bioreactor may include the plurality of biofilm supporting media. The biofilm supporting media may include a fixed media. The biofilm supporting media may include a plurality of the fixed media. The biofilm supporting media may include a suspended media. The suspended media may include beads including polyethylene, polyurethane, or a combination thereof. The suspended media may include a sponge including polyurethane. The biofilm forming bacteria of the biofilm supporting media may consume the contaminants at a rate of at least 0.4 kg BOD/m²/day. The biofilm forming bacteria may have a longer mean cell residence time than the suspended bacteria. The method may further include continuously growing the biofilm of biofilm forming bacteria at a rate of at least 0.05 kg of biofilm growth per kilogram BOD consumed, with the remaining mass forming byproducts. A peak flowrate of the bioreactor may be greater than 3.5 times an average daily flowrate of the bioreactor. The filter may include a permeable substrate. The method may further include: deliberately fouling the permeable substrate to form a layer of deposited solids from the filterable water on the permeable substrate, removing at least a portion of the layer, and mixing the removed portion of the layer with at least a portion of the filterable water to form the sludge with the at least 10,000 mg/L of total suspended solids. The filter may include a permeable substrate. The method may further include: deliberately fouling the permeable substrate to form a layer of deposited solids from the filterable water on the permeable substrate, removing at least a portion of the layer, and mixing the removed portion of the layer with at least a portion of the filterable water to form the sludge with at least 10,000 mg/L and below 70,000 mg/L of total suspended solids. The filter may include a permeable substrate. The method may further include: deliberately fouling the permeable substrate to form a layer of deposited solids from the filterable water on the permeable substrate, removing at least a portion of the layer, and mixing the removed portion of the layer with at least a portion of the filterable water to form the sludge with at least 10,000 mg/L and below 50,000 mg/L of total suspended solids. The filter may include a permeable substrate. The method may further include: deliberately fouling the permeable substrate to form a layer of deposited solids from the filterable water on the permeable substrate, removing at least a portion of the layer, and mixing the removed portion of the layer with at least a portion of the filterable water to form the sludge with at least 15,000 mg/L and below 25,000 mg/L of total suspended solids. The method may further include: monitoring the total suspended solids of the sludge; and controlling the filtering of the filterable water to maintain a sludge having at least 10,000 mg/L total suspended solids. The method may further include spraying at least a portion of the filtrate at the permeable substrate to remove at least a portion of the layer of deposited solids. The filtering may be performed by a liquid-permeable filtering element having a first face and a second face opposite of the first face, where at least an area of the first face of the filtering element is subject to filterable water under pressure and a pressure across said area is greater than 0 and less than or equal to 5.9 kPa, where the sludge is accumulated on the first face of the filtering element. The filter may further include at least one nozzle that directs at least one jet at the second face of the filtering element, through the filtering element, and towards the first face of the filtering element to remove and/or aid in removal of the layer of deposited solids. The liquid-permeable filtering element may be arranged to be cycled through the filterable water such that: in a first position, an area of the first face of the filtering element is subject to filterable water under pressure and a pressure across the filtering element greater than 0 and less than or equal to 5.9 kPa; and in a second position, the area is not subjected to filterable water under pressure or is subjected to filterable water at a lower pressure. The filtering element may be configured to be cycled at a speed such that a thickness of a layer of deposited solids when the filtering element reaches the second position is between 0 and 6 cm. A pore size of the filtering element may be between 2 and 40 μm. A level of dissolved oxygen in the sludge may be no more than 0.5 mg/L. The level of dissolved oxygen in the sludge may be no more than 0.1 mg/L. A level of nitrate (NO₃) in the sludge may be no more than 3 mg/L. A height of a destination of the sludge and a height of a source of the sludge may be arranged to reduce a height difference between the source and the destination, and/or to reduce a pumping head requirement of at least one pump.

In another non-limiting example of the present invention, a wastewater treatment plant for processing wastewater includes: a bioreactor including: an inlet zone for receiving wastewater, a filtration zone including a filter for producing a filtrate and a sludge; and a reaction zone between the inlet zone and the filtration zone including: a biofilm supporting media including a biofilm of biofilm forming bacteria thereon, where the biofilm supporting media is provided in a sufficient quantity to enable the biofilm forming bacteria thereon to consume at least a portion of the contaminants from the wastewater to produce filterable water that has a total suspended solids of less than 5 g/L; and water including suspended bacteria; where the reaction zone includes anoxic and/or aerobic conditions to cause consumption of the contaminants by the biofilm forming bacteria on the biofilm supporting media and the suspended bacteria contained in the water to produce the filterable water; where the filter produces a filtrate and a sludge from the filterable water; and where the filtrate has a total suspended solids of less than 10 mg/L with a flowrate of at least 2,000 L/h per m² of filter area.

The wastewater treatment plant may further include a mechanism to transfer the sludge from the filter to the inlet zone. The mechanism may include a pump and at least one transfer pipe between the filter and the inlet zone. The transfer pipe may include a wastewater inlet. The wastewater treatment plant may further include a contactor having an inlet from the wastewater inlet and an inlet from the transfer pipe. The mechanism may be a differential height between the inlet zone and an external tank provided for the filter. The biofilm forming bacteria may consume at least 75% by mass of the contaminants. The wastewater treatment plant may further include a mechanism to transfer the filtrate external of the bioreactor. The wastewater treatment plant may further include a mechanism to transfer at least a portion of the sludge external of the bioreactor. The wastewater treatment plant may further include an aeration zone including gas feeders in the reaction zone. The gas feeders may maintain a level of total suspended solids in the water at less than 5,000 mg/L. The gas feeders may introduce gas bubbles that discharge excess biofilm forming bacteria on the biofilm forming media into the water. The bioreactor may include a single tank including the inlet zone, the reaction zone, and the filtration zone. The bioreactor may include a plurality of tanks that are interconnected. The plurality of tanks may include a first tank including the inlet zone, a second tank including the reaction zone, and a third tank including the filtration zone. The filtrate may have a flow rate of at least 3,000 L/h per m² of filter area. The bioreactor may include a plurality of biofilm supporting media. The inlet zone, the filtration zone, and/or the reaction zone of the bioreactor may include the plurality of biofilm supporting media. The biofilm supporting media may include a fixed media. The biofilm supporting media may include a plurality of the fixed media. The biofilm supporting media may include a suspended media. The suspended media may include beads including polyethylene, polyurethane, or a combination thereof. The suspended media may include a sponge including polyurethane. The biofilm forming bacteria of the biofilm supporting media may consume the contaminants at a rate of at least 0.4 kg BOD/m²/day. The biofilm forming bacteria may have a longer mean cell residence time than the suspended bacteria. The biofilm forming bacteria may grow on the biofilm supporting media at a rate of at least 0.05 kg of biofilm growth per kilogram BOD consumed, with the remaining mass forming byproducts. A peak flowrate of the bioreactor may be greater than 3.5 times an average daily flow rate of the bioreactor. The filter may include a permeable substrate. The permeable substrate may be deliberately fouled to form a layer of deposited solids from the filterable water so as to achieve the sludge with the at least 10,000 mg/L of total suspended solids. The filter may include a permeable substrate. The permeable substrate may be deliberately fouled to form a layer of deposited solids from the filterable water so as to achieve the sludge with at least 10,000 mg/L and below 70,000 mg/L of total suspended solids. The filter may include a permeable substrate. The permeable substrate may be deliberately fouled to form a layer of deposited solids from the filterable water so as to achieve the sludge with at least 10,000 mg/L and below 50,000 mg/L of total suspended solids. The filter may include a permeable substrate. The permeable substrate may be deliberately fouled to form a layer of deposited solids from the filterable water so as to achieve the sludge with at least 15,000 mg/L and below 25,000 mg/L of total suspended solids. The filter may include a liquid-permeable filtering element including a first face and a second face opposite of the first face, where the liquid-permeable filtering element is at least partially submerged in the filterable water. The liquid-permeable filtering element may be arranged to be cycled through the filterable water such that: in a first position, an area of the first face of the filtering element is subject to filterable water under pressure and a pressure across the filtering element greater than 0 and less than or equal to 5.9 kPa; and in a second position, the area is not subjected to filterable water under pressure or is subjected to filterable water at a lower pressure. The filter may include at least one nozzle that directs at least one jet at the second face of the filtering element, through the filtering element, and towards the first face of the filtering element to remove and/or aid in removal of the deposited solids accumulated on the first face of the filtering element. The filtering element may be configured to be cycled at a speed such that a thickness of a layer of deposited solids when the filtering element reaches the second position is between 0 and 6 cm. A pore size of the filtering element may be between 2 and 40 μm. A level of dissolved oxygen in the sludge may be no more than 0.5 mg/L. The level of dissolved oxygen in the sludge may be no more than 0.1 mg/L. A level of nitrate (NO₃) in the sludge may be no more than 3 mg/L. The wastewater treatment plant may further include a media screen in the reaction zone to prevent the biofilm supporting media from entering the filtration zone.

Various preferred and non-limiting examples or aspects of the present invention will now be described and set forth in the following numbered clauses:

Clause 1: A method for removing contaminants from wastewater to produce a filtrate and a sludge: the steps comprising: providing a bioreactor comprising: an inlet zone for receiving wastewater, a filtration zone comprising a filter; and a reaction zone between the inlet zone and the filtration zone comprising: a biofilm supporting media comprising a biofilm of biofilm forming bacteria thereon, wherein the biofilm supporting media is provided in a sufficient quantity to enable the biofilm forming bacteria thereon to consume at least a portion of the contaminants from the wastewater to produce filterable water that has a total suspended solids of less than 5 g/L at the filtration zone; and water comprising suspended bacteria; and introducing wastewater comprising contaminants to the inlet zone of the bioreactor; providing anoxic and/or aerobic conditions in the reaction zone of the bioreactor to cause the consumption of the contaminants by the biofilm forming bacteria on the biofilm supporting media and the suspended bacteria contained in the water to produce filterable water; and filtering the filterable water at the filtration zone to produce a filtrate and a sludge, wherein the filtrate has total suspended solids of less than 10 mg/L with a flowrate of at least 2,000 L/h per m² of filter area.

Clause 2: The method of clause 1, wherein the biofilm forming bacteria consumes at least 75% by mass of the contaminants.

Clause 3: The method of clause 1 or 2, further comprising transferring the filtrate external of the bioreactor.

Clause 4: The method of any of clauses 1-3, further comprising transferring at least a portion of the sludge external of the bioreactor.

Clause 5: The method of any of clauses 1-4, further comprising transferring at least a portion of the sludge to the inlet zone.

Clause 6: The method of clause 5, wherein the transferring at least a portion of the sludge to the inlet zone step comprises pumping the sludge to the inlet zone.

Clause 7: The method of clause 6, wherein the transferring at least a portion of the sludge to the inlet zone step further comprises actively mixing the sludge with the wastewater and/or filterable water in a transfer pipe.

Clause 8: The method of any of clauses 1-7, further comprising aerating the water in the reaction zone such that the water comprises less than 5,000 mg/L of total suspended solids.

Clause 9: The method of any of clauses 1-8, further comprising discharging excess biofilm forming bacteria on the biofilm supporting media into the water.

Clause 10: The method of clause 9, further comprising aerating the biofilm supporting media to discharge excess biofilm forming bacteria on the biofilm supporting media into the water.

Clause 11: The method of any of clauses 1-10, wherein the bioreactor comprises a single tank comprising the inlet zone, the reaction zone, and the filtration zone.

Clause 12: The method of any of clauses 1-11, wherein the bioreactor comprises a plurality of tanks that are interconnected.

Clause 13: The method of clause 12, wherein the plurality of tanks comprises a first tank comprising the inlet zone, a second tank comprising the reaction zone, and a third tank comprising the filtration zone.

Clause 14: The method of any of clauses 1-13, wherein the filtrate has a flow rate of at least 3,000 L/h per m² of filter area.

Clause 15: The method of any of clauses 1-14, wherein the bioreactor comprises a plurality of biofilm supporting media.

Clause 16: The method of clause 15, wherein the inlet zone, filtration zone, and/or the reaction zone of the bioreactor comprises the plurality of biofilm supporting media.

Clause 17: The method of any of clauses 1-16, wherein the biofilm supporting media comprises a fixed media.

Clause 18: The method of clause 17, wherein the biofilm supporting media comprises a plurality of the fixed media.

Clause 19: The method of any of clauses 1-18, wherein the biofilm supporting media comprises a suspended media.

Clause 20: The method of clause 19, wherein the suspended media comprises beads comprising polyethylene, polyurethane, or a combination thereof.

Clause 21: The method clause 19 or 20, wherein the suspended media comprises a sponge comprising polyurethane.

Clause 22: The method of any of clauses 1-21, wherein the biofilm forming bacteria of the biofilm supporting media consumes the contaminants at a rate of at least 0.4 kg BOD/m²/day.

Clause 23: The method of any of clauses 1-22, wherein the biofilm forming bacteria has a longer mean cell residence time than the suspended bacteria.

Clause 24: The method of any of clauses 1-23, further comprising continuously growing the biofilm of biofilm forming bacteria at a rate of at least 0.05 kg of biofilm growth per kilogram BOD consumed, with the remaining mass forming byproducts.

Clause 25: The method of any of clauses 1-24, wherein a peak flowrate of the bioreactor is greater than 3.5 times an average daily flowrate of the bioreactor.

Clause 26: The method of any of clauses 1-25, wherein the filter comprises a permeable substrate, and further comprising: deliberately fouling the permeable substrate to form a layer of deposited solids from the filterable water on the permeable substrate, removing at least a portion of the layer, and mixing the removed portion of the layer with at least a portion of the filterable water to form the sludge with the at least 10,000 mg/L of total suspended solids.

Clause 27: The method of any of clauses 1-26, wherein the filter comprises a permeable substrate, and further comprising: deliberately fouling the permeable substrate to form a layer of deposited solids from the filterable water on the permeable substrate, removing at least a portion of the layer, and mixing the removed portion of the layer with at least a portion of the filterable water to form the sludge with at least 10,000 mg/L and below 70,000 mg/L of total suspended solids.

Clause 28: The method of any of clauses 1-27, wherein the filter comprises a permeable substrate, and further comprising: deliberately fouling the permeable substrate to form a layer of deposited solids from the filterable water on the permeable substrate, removing at least a portion of the layer, and mixing the removed portion of the layer with at least a portion of the filterable water to form the sludge with at least 10,000 mg/L and below 50,000 mg/L of total suspended solids.

Clause 29: The method of any of clauses 1-28, wherein the filter comprises a permeable substrate, and further comprising: deliberately fouling the permeable substrate to form a layer of deposited solids from the filterable water on the permeable substrate, removing at least a portion of the layer, and mixing the removed portion of the layer with at least a portion of the filterable water to form the sludge with at least 15,000 mg/L and below 25,000 mg/L of total suspended solids.

Clause 30: The method of any of clauses 1-29, further comprising: monitoring the total suspended solids of the sludge; and controlling the filtering of the filterable water to maintain a sludge having at least 10,000 mg/L total suspended solids.

Clause 31: The method of any one of clauses 26-30, further comprising spraying at least a portion of the filtrate at the permeable substrate to remove at least a portion of the layer of deposited solids.

Clause 32: The method of any one of clauses 1-31, wherein the filtering is performed by a liquid-permeable filtering element having a first face and a second face opposite of the first face, wherein at least an area of the first face of the filtering element is subject to filterable water under pressure and a pressure across said area is greater than 0 and less than or equal to 5.9 kPa, wherein the sludge is accumulated on the first face of the filtering element.

Clause 33: The method of clause 32, wherein the filter further comprises at least one nozzle that directs at least one jet at the second face of the filtering element, through the filtering element, and towards the first face of the filtering element to remove and/or aid in removal of the layer of deposited solids.

Clause 34: The method clause 32 or 33, wherein the liquid-permeable filtering element is arranged to be cycled through the filterable water such that: in a first position, an area of the first face of the filtering element is subject to filterable water under pressure and a pressure across the filtering element greater than 0 and less than or equal to 5.9 kPa; and in a second position, the area is not subjected to filterable water under pressure or is subjected to filterable water at a lower pressure.

Clause 35: The method clause 34, wherein the filtering element is configured to be cycled at a speed such that a thickness of a layer of deposited solids when the filtering element reaches the second position is between 0 and 6 cm.

Clause 36: The method of any of clauses 32-35, wherein a pore size of the filtering element is between 2 and 40 μm.

Clause 37: The method of any of clauses 1-36, wherein a level of dissolved oxygen in the sludge is no more than 0.5 mg/L.

Clause 38: The method of any of clauses 1-37, wherein the level of dissolved oxygen in the sludge is no more than 0.1 mg/L.

Clause 39: The method of any of clauses 1-38, wherein a level of nitrate (NO₃) in the sludge is no more than 3 mg/L.

Clause 40: The method of any of clauses 1-39, wherein a height of a destination of the sludge and a height of a source of the sludge are arranged to reduce a height difference between the source and the destination, and/or to reduce a pumping head requirement of at least one pump.

Clause 41: A wastewater treatment plant for processing wastewater, comprising: a bioreactor comprising: an inlet zone for receiving wastewater, a filtration zone comprising a filter for producing a filtrate and a sludge; and a reaction zone between the inlet zone and the filtration zone comprising: a biofilm supporting media comprising a biofilm of biofilm forming bacteria thereon, wherein the biofilm supporting media is provided in a sufficient quantity to enable the biofilm forming bacteria thereon to consume at least a portion of the contaminants from the wastewater to produce filterable water that has a total suspended solids of less than 5 g/L; and water comprising suspended bacteria; wherein the reaction zone comprises anoxic and/or aerobic conditions to cause consumption of the contaminants by the biofilm forming bacteria on the biofilm supporting media and the suspended bacteria contained in the water to produce the filterable water; wherein the filter produces a filtrate and a sludge from the filterable water; and wherein the filtrate has a total suspended solids of less than 10 mg/L with a flowrate of at least 2,000 L/h per m² of filter area.

Clause 42: The wastewater treatment plant of clause 41, further comprising a mechanism to transfer the sludge from the filter to the inlet zone.

Clause 43: The wastewater treatment plant of clause 42, wherein the mechanism comprises a pump and at least one transfer pipe between the filter and the inlet zone.

Clause 44: The wastewater treatment plant of clause 43, wherein the transfer pipe comprises a wastewater inlet.

Clause 45: The wastewater treatment plant of clause 44, further comprising a contactor having an inlet from the wastewater inlet and an inlet from the transfer pipe.

Clause 46: The wastewater treatment plant of clause 45, wherein the mechanism is a differential height between the inlet zone and an external tank provided for the filter.

Clause 47: The wastewater treatment plant of any of clauses 41-46, where the biofilm forming bacteria consumes at least 75% by mass of the contaminants.

Clause 48: The wastewater treatment plant of any of clauses 41-47, further comprising a mechanism to transfer the filtrate external of the bioreactor.

Clause 49: The wastewater treatment plant of any of clauses 41-48, further comprising a mechanism to transfer at least a portion of the sludge external of the bioreactor.

Clause 50: The wastewater treatment plant of any of clauses 41-49, further comprising an aeration zone comprising gas feeders in the reaction zone.

Clause 51: The wastewater treatment plant of clause 50, wherein the gas feeders maintain a level of total suspended solids in the water at less than 5,000 mg/L.

Clause 52: The wastewater treatment plant of clause 50 or 51, wherein the gas feeders introduce gas bubbles that discharge excess biofilm forming bacteria on the biofilm forming media into the water.

Clause 53: The wastewater treatment plant of any of clauses 41-52, wherein the bioreactor comprises a single tank comprising the inlet zone, the reaction zone, and the filtration zone.

Clause 54: The wastewater treatment plant of any of clauses 41-52, wherein the bioreactor comprises a plurality of tanks that are interconnected.

Clause 55: The wastewater treatment plant of clause 54, wherein the plurality of tanks comprises a first tank comprising the inlet zone, a second tank comprising the reaction zone, and a third tank comprising the filtration zone.

Clause 56: The wastewater treatment plant of any of clauses 41-55, wherein the filtrate has a flow rate of at least 3,000 L/h per m² of filter area.

Clause 57: The wastewater treatment plant of any of clauses 41-56, wherein the bioreactor comprises a plurality of biofilm supporting media.

Clause 58: The wastewater treatment plant of clause 57, wherein the inlet zone, the filtration zone, and/or the reaction zone of the bioreactor comprises the plurality of biofilm supporting media.

Clause 59: The wastewater treatment plant of any of clauses 41-58, wherein the biofilm supporting media comprises a fixed media.

Clause 60: The wastewater treatment plant of any of clauses 41-59, wherein the biofilm supporting media comprises a plurality of the fixed media.

Clause 61: The wastewater treatment plant of any of clauses 41-60, wherein the biofilm supporting media comprises a suspended media.

Clause 62: The wastewater treatment plant of clause 61, wherein the suspended media comprises beads comprising polyethylene, polyurethane, or a combination thereof.

Clause 63: The wastewater treatment plant of clause 61 or 62, wherein the suspended media comprises a sponge comprising polyurethane.

Clause 64: The wastewater treatment plant of any of clauses 41-63, wherein the biofilm forming bacteria of the biofilm supporting media consumes the contaminants at a rate of at least 0.4 kg BOD/m²/day.

Clause 65: The wastewater treatment plant of any of clauses 41-64, wherein the biofilm forming bacteria has a longer mean cell residence time than the suspended bacteria.

Clause 66: The wastewater treatment plant of any of clauses 41-65, wherein the biofilm forming bacteria grows on the biofilm supporting media at a rate of at least 0.05 kg of biofilm growth per kilogram BOD consumed, with the remaining mass forming byproducts.

Clause 67: The wastewater treatment plant of any of clauses 41-66, wherein a peak flowrate of the bioreactor is greater than 3.5 times an average daily flow rate of the bioreactor.

Clause 68: The wastewater treatment plant of any one of clauses 41-67, wherein the filter comprises a permeable substrate and wherein the permeable substrate is deliberately fouled to form a layer of deposited solids from the filterable water so as to achieve the sludge with the at least 10,000 mg/L of total suspended solids.

Clause 69: The wastewater treatment plant of clauses 41-68, wherein the filter comprises a permeable substrate and wherein the permeable substrate is deliberately fouled to form a layer of deposited solids from the filterable water so as to achieve the sludge with at least 10,000 mg/L and below 70,000 mg/L of total suspended solids.

Clause 70: The wastewater treatment plant of any one of clauses 41-69, wherein the filter comprises a permeable substrate and wherein the permeable substrate is deliberately fouled to form a layer of deposited solids from the filterable water so as to achieve the sludge with at least 10,000 mg/L and below 50,000 mg/L of total suspended solids.

Clause 71: The wastewater treatment plant of any one of clauses 41-70, wherein the filter comprises a permeable substrate and wherein the permeable substrate is deliberately fouled to form a layer of deposited solids from the filterable water so as to achieve the sludge with at least 15,000 mg/L and below 25,000 mg/L of total suspended solids.

Clause 72: The wastewater treatment plant of any one of clauses 41-71, wherein the filter comprises a liquid-permeable filtering element comprising a first face and a second face opposite of the first face, wherein the liquid-permeable filtering element is at least partially submerged in the filterable water.

Clause 73: The wastewater treatment plant of clause 72, wherein the liquid-permeable filtering element is arranged to be cycled through the filterable water such that: in a first position, an area of the first face of the filtering element is subject to filterable water under pressure and a pressure across the filtering element greater than 0 and less than or equal to 5.9 kPa; and in a second position, the area is not subjected to filterable water under pressure or is subjected to filterable water at a lower pressure.

Clause 74: The wastewater treatment plant of clause 72 or 73, wherein the filter comprises at least one nozzle that directs at least one jet at the second face of the filtering element, through the filtering element, and towards the first face of the filtering element to remove and/or aid in removal of the deposited solids accumulated on the first face of the filtering element.

Clause 75: The wastewater treatment plant of clause 73 or 74, wherein the filtering element is configured to be cycled at a speed such that a thickness of a layer of deposited solids when the filtering element reaches the second position is between 0 and 6 cm.

Clause 76: The wastewater treatment plant of any of clauses 72-75, wherein a pore size of the filtering element is between 2 and 40 μm.

Clause 77: The wastewater treatment plant of any of clauses 41-76, wherein a level of dissolved oxygen in the sludge is no more than 0.5 mg/L.

Clause 78: The wastewater treatment plant of any of clauses 41-77, wherein the level of dissolved oxygen in the sludge is no more than 0.1 mg/L.

Clause 79: The wastewater treatment plant of any of clauses 41-78, wherein a level of nitrate (NO₃) in the sludge is no more than 3 mg/L.

Clause 80: The wastewater treatment plant of any of clauses 41-79, further comprising a media screen in the reaction zone to prevent the biofilm supporting media from entering the filtration zone.

### BRIEF DESCRIPTION OF THE DRAWINGS

FIG. 1A is a schematic diagram of a wastewater processing system known in the art;

FIG. 1B is a schematic diagram of a wastewater processing system known in the art;

FIG. 2A is a schematic diagram of a wastewater processing system according to one aspect of the present invention;

FIG. 2B is a schematic diagram of a wastewater processing system according to another aspect of the present invention;

FIG. 3A is a schematic diagram of a wastewater processing system according to another aspect of the present invention;

FIG. 3B is a schematic diagram of a wastewater processing system according to another aspect of the present invention;

FIG. 4A is a schematic diagram of a wastewater processing system according to another aspect of the present invention;

FIG. 4B is a schematic diagram of a wastewater processing system according to another aspect of the present invention;

FIG. 5 is a cross-sectional view of a filter according to another aspect of the present invention;

FIG. 6 is a schematic view of a plurality of liquid-permeable filtering elements arranged as a disc according to another aspect of the present invention;

FIG. 7 is a schematic view of a plurality of liquid-permeable filtering elements arranged as a drum according to another aspect of the present invention; and

FIG. 8 is a schematic view of a filter according to another aspect of the present invention.

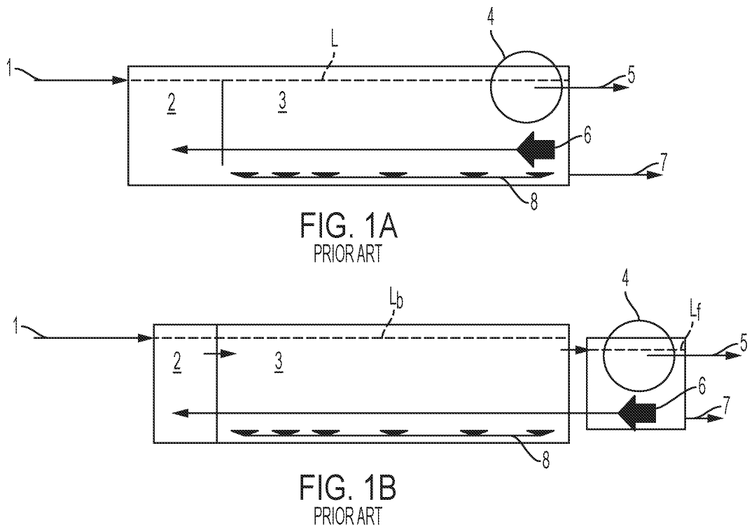

### DESCRIPTION OF THE INVENTION

For purposes of the description hereinafter, the terms “upper,” “lower,” “right.” “left.” “vertical,” “horizontal,” “top.” “bottom.” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

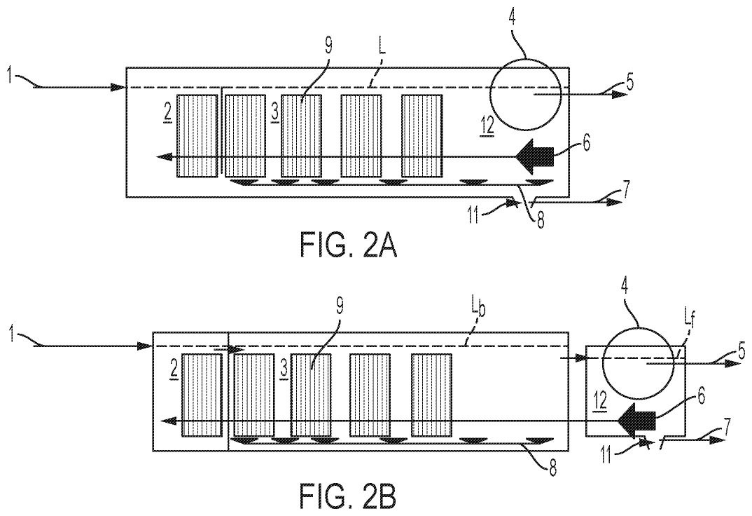

Referring to FIGS. 2A-4B, a wastewater treatment system for processing wastewater to produce a sludge 7 and a clean water filtrate 5 is provided. Wastewater 1 is provided from a source of wastewater to an inlet zone 2 of a bioreactor. The wastewater 1 is commonly supplied to the inlet zone 2 from supply infrastructure in the ground for contaminated water, which are common in many water processing systems. Said infrastructure and its corresponding piping network can be reused with minor upgrades to the pumping stations for the systems described herein. Other non-limiting examples of sources of wastewater 1 include: municipal, industrial, and/or agricultural sources; such as for example, municipal wastewater 1.

The wastewater 1 that enters the inlet zone 2 may be subject to various processes. For example, the wastewater 1 may be subject to coarse screening to remove contaminants having a size of 20 mm or greater, followed by fine screening to remove contaminants having a size of 6 mm or greater. Further processes may include fat removal, which is not essential at the front end of the system, but may be retained if using a pre-existing plant that includes fat removal. The grit, sand, and other contaminants removed from the wastewater 1 in the inlet zone 2 may be disposed of by any conventional means, such as disposed of in a landfill. The inlet zone 2 may comprise at least one biological process. Non-limiting examples of biological processes that may be present in the inlet zone 2 include nitrification, denitrification, an anoxic zone, and combinations thereof. Alternatively, the inlet zone 2 may be free of any biological processes, such that no biological processes take place in the inlet zone 2.

The liquid stream that exits the inlet zone 2 is considered treated sewage and/or wastewater 1 that is free of large debris and contaminants, but that still contains dissolved organics, inorganics, and suspended solids. The wastewater 1 may contain various amounts of dissolved or suspended solids. For example wastewater 1 may include from 500-600 mg of chemical oxygen demand per liter (mgCOD/L), from 200-300 mg of Biological oxygen demand per liter (mgBOD/L), from 40-60 mg of total Kjeldahl nitrogen, measured as elemental nitrogen, per liter (mgTKN-n/L), from 30-45 mg of ammonia, measured as elemental nitrogen, per liter (mgNH₄-n/L), from 200-400 mg of total suspended solids per liter (mgTSS/L), from 5-12 mg of total phosphorus per liter (mgTP/L), E. coli in an amount of greater than 10⁶ colony forming units per 100 milliliters (CFU/100 mL), and/or fecal coliforms in an amount from 1700-5000/100 mL. These values are common levels of dissolved and/or suspended species in typical municipal sewage. Municipal wastewater may or may not have amounts of dissolved and/or suspended species in the same range as above; however, may still be used in the systems defined herein. Other pathogens, such as Helminth eggs and/or virus materials, may be present depending on the geographic location and may also be removed in the current process.

The wastewater 1 may be industrial or municipal, and may include material having a size of less than 20 mm. It may be advantageous for the present systems and processes to have a range of organic material contaminants in the wastewater (8) measured as COD, BOD, and TKN as well as having some amount of total suspended solids (TSS).

After the wastewater 1 exits the inlet zone 2, the wastewater 1 enters reaction zone 3 of the bioreactor. The wastewater 1 that enters the reaction zone 3 may include suspended bacteria and contaminants, such as, for example, the various compounds previously discussed, that contribute to the total suspended solids content in the wastewater 1 in the reaction zone 3. The biofilm forming bacteria also has the advantage of consuming other more difficult to remove contaminants, such as sugars and phosphorus. The reaction zone 3 may include a biofilm supporting media 9, such as a plurality of biofilm supporting media 9. Biofilm supporting media may also be present in the inlet zone 2 and/or the filtration zone 6 which will be described below. Alternatively, no biofilm supporting media 9 may be present in the inlet zone 2 and/or the filtration zone 6.

The biofilm supporting media 9 includes a biofilm of biofilm forming bacteria on the surface of the biofilm forming media 9. This bacteria is naturally occurring in the wastewater 1 and/or the air surrounding the bioreactor and is deposited onto the biofilm forming media 9 as the wastewater 1 moves through the reaction zone 3. Due to the presence of the suspended bacteria in the wastewater 1 in the reaction zone 3, the biofilm may be continuously grown by continuous deposition of biofilm forming bacteria onto the biofilm supporting media 9. For example the biofilm of biofilm forming bacteria on the biofilm supporting media 9 may be continuously grown at a rate of at least 0.05 kg of biofilm growth per kg BOD consumed, with the remaining mass forming byproducts, such as 1 kg of biofilm growth per kg BOD consumed. Non-limiting examples of byproducts include carbon dioxide, nitrates, and the like. Biofilm growth per kg BOD consumed can be calculated based on the surface area of the biofilm supporting media 9 and the BOD coming into the bioreactor compared to the BOD existing in the bioreactor and the total sludge removed from the system to maintain the solids balance. As used herein, unless stated otherwise, surface area of the biofilm supporting media 9 is measured using Brunauer-Emmett-Teller theory, BOD is measured with ISO 5815-1, and total suspended solids content (sludge) is measured using ISO 11923:1997.

Over time, the bacteria deposited on the surface of the biofilm supporting media 9 forms a biofilm on the surface of the biofilm supporting media 9. This biofilm of bacteria consumes contaminants present in the wastewater 1 in the reaction zone 3. The biofilm supporting media 9 is provided in a sufficient quantity to enable the biofilm forming bacteria thereon to consume at least a portion of the contaminants from the wastewater 1 to produce filterable water 12 that has a total suspended solids of less than 5 g/L at the filtration zone 6. For example, the biofilm forming bacteria may consume at least 75% by mass of the contaminants present in the wastewater 1 in the reaction zone 3, which can be calculated using the measurement techniques for total suspended solids, BOD, and surface area described herein. In one non-limiting embodiment, the biofilm forming bacteria of the biofilm supporting media 9 consumes the contaminants at a rate of at least 0.4 kg of BOD/m²/day. The biofilm forming bacteria of the biofilm supporting media 9 may have a longer mean cell residence time compared to the suspended bacteria present in the wastewater 1.

The biofilm supporting media 9 may comprise a fixed media, as shown in FIGS. 2A-2B. A “fixed” media refers to blocks of carrier material that are secured in the reaction zone 3, as well as the inlet zone 2 and/or filtration zone 6. For example, the fixed media may be “curtains” or other large blocks of material.

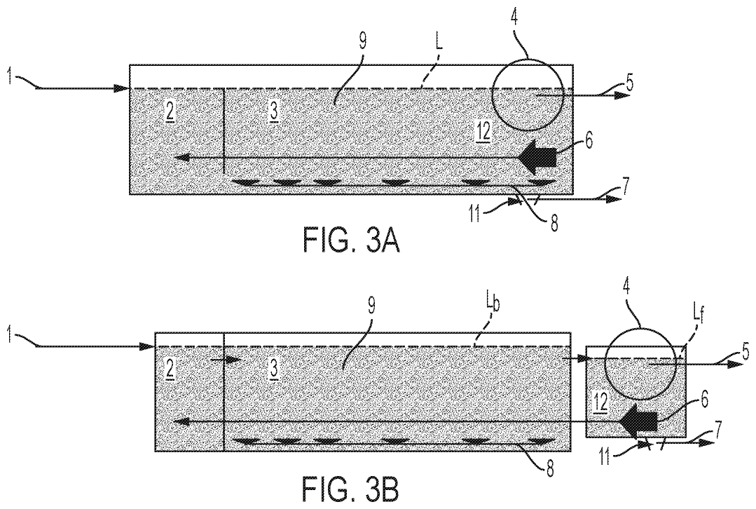

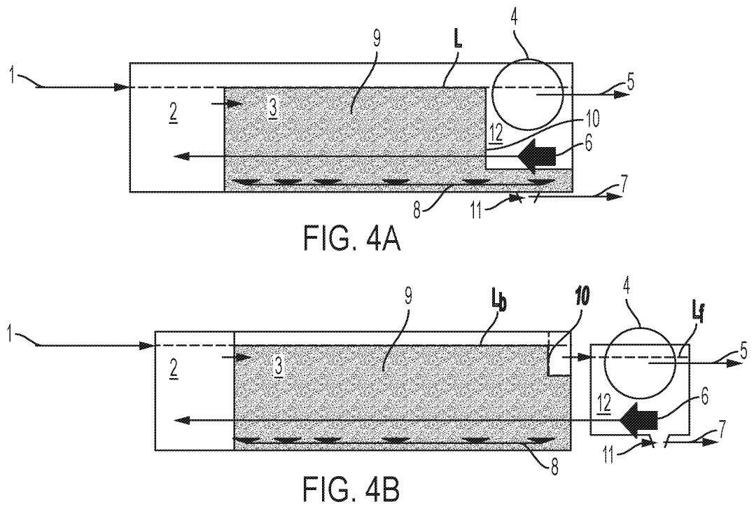

The biofilm supporting media 9 may comprise a suspended media, as shown in FIGS. 3A-4B. A “suspended” media refers to free-moving media that is suspended by mixing and/or by aerators 8 in the reaction zone 3, as well as the inlet zone 2 and/or filtration zone 6. The suspended media may include a hard media, such as beads of material. The suspended hard media may include polyethylene, polyurethane, or a combination thereof. The suspended media may include soft media, such as a sponge. The suspended soft media may include polyurethane.

The reaction zone 3 may include anoxic and/or aerobic conditions. The presence of anoxic and/or aerobic conditions at the reaction zone 3 aids in the consumption of the contaminants by the biofilm supporting media and the suspended bacteria present in the wastewater 1.

Aerators 8 may be present in the reaction zone 3, inlet zone 2, and/or the filtration zone 6 to aid in the continued suspension of the total suspended solids in the wastewater 1. The aerators 8 may aerate the wastewater 1 in the reaction zone 3 such that the wastewater 1 includes less than 5,000 mg/L of total suspended solids. Excess biofilm forming bacteria that forms the biofilm on the biofilm supporting media 9 may be discharged off of the biofilm supporting media 9 into the wastewater 1. For example, the aerating from the aerators 8 may discharge excess biofilm forming bacteria of the biofilm on the biofilm supporting media 9 into the wastewater 1. If suspended biofilm supporting media 9 is present in the bioreactor, the aerators may also aid in the suspension of the suspended biofilm supporting media 9.

The remaining suspended solids in the wastewater 1, after the biofilm forming bacteria on the biofilm supporting media 9 consumes at least a portion of the contaminants, may be flocculated to form floc. “Floc” refers to conglomerated organic material suspended in wastewater 1. The floc may be larger than typical floc in wastewater systems, which typically has a size of 20 microns. For example, the floc in the present systems and/or methods may have a size of greater than 200 microns, or greater than 500 microns, or greater than 1,000 microns, or greater than 2,000 microns. The size of the floc, as described herein, may be determined using a microscope and a corresponding microscope scale.

After the wastewater 1 exits the reaction zone 3, the wastewater 1 is filterable water 12 which includes less than 5 g/L of total suspended solids. By providing the biofilm supporting media 9 in a sufficient quantity, biofilm forming bacteria is able to consume at least a portion of the contaminants from the wastewater 1 to produce filterable water 12 that has a total suspended solids of less than 5 g/L at the filtration zone 6. A “sufficient quantity” of biofilm supporting media 9 refers to a sufficient surface area to form a biofilm of biofilm forming bacteria that can consume enough contaminants to produce a filterable water 12 having a total suspended solids content of less than 5 g/L. This sufficient surface area can be calculated using the consumption rate of 0.4 kg BOD/m²/day and the percentage of contaminants to be removed from the wastewater 1, for example 75% contaminant mass removal. If the amount of biofilm supporting media 9 is insufficient to achieve less than 5 g/L of total suspended solids in the filterable water 12, then additional biofilm supporting media 9 can be added. For example, additional biofilm supporting media 9 can be added until the filterable water 12 at the reaction zone 3 has a total suspended solids content of less than 5 g/L, such as less than 3 g/L, such as less than 2 g/L.

After the wastewater 1 exits the reaction zone 3 as filterable water 12, having total suspended solids of less than 5 g/L due in part to the consumption of contaminants by the biofilm forming bacteria of the biofilm on the biofilm supporting media 9, the filterable water 12 enters the filtration zone 6. The filtration zone 6 includes a filter 4. A media screen 10 may be provided at the filtration zone 6 and/or the reaction zone 3 (e.g., an interface thereof) to prevent biofilm supporting media 9 from entering the filtration zone 6 and/or from entering the filter 4.

The bioreactor may include a single tank that includes each of the inlet zone 2, the reaction zone 3, and the filtration zone 6. The bioreactor may include a plurality of tanks that are interconnected. For example, the bioreactor may include a first tank including the inlet zone 2, a second tank including the reaction zone 3, and a third tank including the filtration zone 6. The single tank or the plurality of tanks of the bioreactor may be connected by piping to allow the wastewater 1 to exit each zone and enter the next zone. If each of the inlet zone 2, the reaction zone 3, and the filtration zone 6 are present in a single tank, the wastewater 1 in the bioreactor may have a level L such that a filter 4 is at least partially submerged in the wastewater 1. If, for example, the filtration zone 6 is separate from the bioreactor including inlet zone 2 and the reaction zone 3, the bioreactor may have a level L_{b} and the filtration zone 6 may have a level Lf such that the filter 4 is at least partially submerged in the filterable water 12.

Filtering may be done by any filter 4 known in the art. Any of the various embodiments of filter 4 described herein or known in the art may be included in the water treatment system.

According to certain non-limiting embodiments of the present invention, the processes and/or systems may include a filter 4, such as a filtering/thickening machine (FTM). One possible version of the FTM is substantially described in Italian Patent Application Numbers 102018000010259, filed Nov. 12, 2018; 102018000010430, filed Nov. 19, 2018; 102019000011046, filed Jul. 5, 2019; and 102019000011058, filed Jul. 5, 2019. A preferred non-limiting embodiment of an FTM can be found in PCT Application Number PCT/EP2019/074913, filed Sep. 17, 2019, which is hereby incorporated by reference in its entirety.

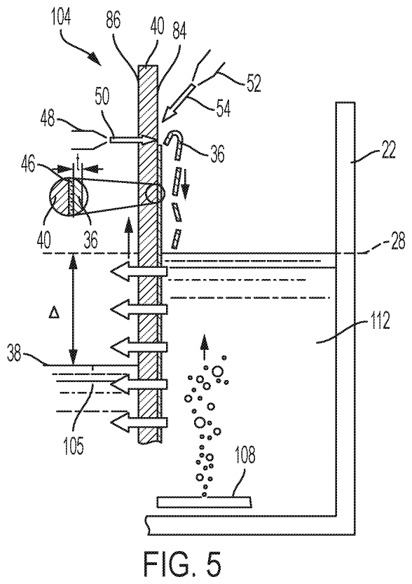

For example, the filter 4 may be filter 104 of FIGS. 5-8. The filter 104 may comprise a container 22 and at least one liquid-permeable filtering element 40, such as a plurality of liquid-permeable filtering elements 40. The container 22 may be any object configured to hold a volume of liquid. The at least one liquid-permeable filtering element 40 may comprise a filtering mesh. The at least one liquid-permeable filtering element 40 may have any shape known in the art. For example, the at least one liquid-permeable filtering element 40 may have a circular or rectangular cross-section. The at least one liquid-permeable filtering element may be a single stationary liquid-permeable filtering element 40. The at least one liquid-permeable filtering element 40 may comprise a plurality of liquid-permeable filtering elements 40. The at least one liquid permeable filtering element 40 comprises a first face 84 and a second face 86 opposite of the first face 84.

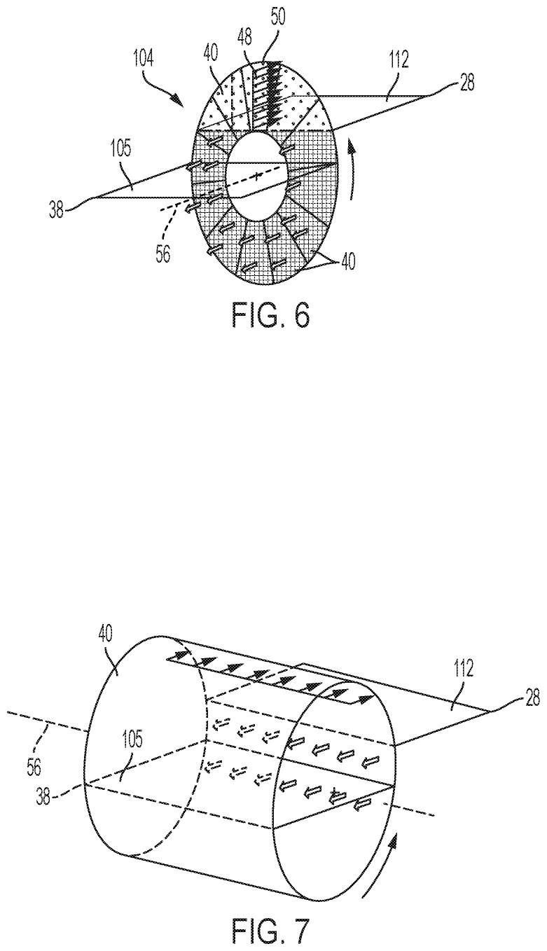

For example, the at least one liquid-permeable filtering element 40 of FIG. 5, such as a plurality of liquid-permeable filtering elements 40, may be in the form of a disc or a drum, such as the disc or drum liquid-permeable filtering element 40 of FIGS. 6-7. For example, the filter 4 in FIGS. 2A-4B may be the filter 104 and include the rotating disc or drum 40 of FIGS. 6-7. If the at least one liquid-permeable filtering element 40 is a disc or a drum 40, the disc or drum 40 may rotate to facilitate filtering. If the liquid-permeable filtering element is a disc or a drum 40, the first face 84 of the disc or drum 40 may be the external surface where the cake layer 36 forms, while the second face 86 is the internal surface of the disc or drum 40 and contained within the disc or drum 40. The cake layer 36 is formed by the deposition of suspended solids in the filterable water 112 onto the liquid-permeable filtering element 40. During rotation of the disc or drum 40, the pressure from the filterable water 112 aids in filtration of the filterable water 112, thereby producing a cake layer 36 on the first face 84 of the disc or drum 40. The filtrate 105 will collect within the disc or drum 40 and be transferred to external to the filter 104 via a transportation apparatus, such as a pump and a transfer pipe.

To avoid excessive stress and turbulence on the filterable water 112 containing suspended solids, the filter 104 may comprise a single, compact container 22, which may be only slightly larger than the at least one liquid-permeable filtering element 40. Alternatively, the filter 104 may comprise a plurality of interconnected containers to contain the at least one liquid-permeable filtering element 40 and the corresponding components of the filter 104. In the filter 104, sedimentation is allowed such that the heavy agglomerates sink to the bottom, known as the sludge outlet 11. Aeration may be applied to the filterable water 112 via at least one aerator 108 located at the bottom of the container 22 of the filter 104 such that suspended solids remain suspended in the filterable water 112 while waiting to be filtered, thus maintaining a homogenized solution of filterable water 112 and suspended solids. The at least one aerator 108 may introduce gas bubbles into the filterable water 112. The gas bubbles may be air, nitrogen, and/or a combination thereof. The air and/or other gases (e.g. nitrogen) supplied by the at least one aerator 108 are sized at least at 1 normal cubic meter of gas per hour per cubic meter of filterable water 112 (Nm³/hr/m³) and up to 20 Nm³/hr/m³, such as 1-4 Nm³/hr/m³. The container 22 of the filter 104 is designed to reduce the retention time of the filterable water 112 in the container 22 to 5 to 15 minutes, such as about 5 minutes. For example, the retention time of the filterable water 112 in the container 22 may not exceed 30 minutes, or may not exceed 60 minutes, or may not exceed 2 hours, or may not exceed 4 hours.

In the filter 104, there may be a small height difference between the side of the liquid-permeable filtering element 40 that includes the filterable water 112 and the side of the at least one liquid-permeable filtering element 40 that contains the filtrate 105. The level 28 of the filterable water 112 in the filter 104 is provided and is higher than the level 38 of the filtrate 105 in the filter 104. The “filtrate” 105 is the filterable water 112 after it has been filtered by the at least one liquid-permeable filtering element 40, thereby removing the suspended solids in the filterable water 112. This height difference is typically up to 25 cm or 0.025 bar. This height difference may aid in maintaining the continuous filtration of the filterable water 112 through the at least one liquid-permeable filtering element 40. The suspended solids will be continuously deposited on the first face 84 of the at least one liquid-permeable filtering element 40 of the filter 104, creating the cake layer 36 of suspended solids that increases in thickness as more suspended solids are deposited. This cake layer 36 will start at a thickness of less than 5 μm and will continuously grow, up to a thickness of 10,000 μm. Depending on the dewaterability of the cake layer 36, the cake layer 36 may even reach a thickness of up to 4 cm, or greater than 4 cm. This cake layer 36 can thicken on the first face 84 of the liquid-permeable filtering element 40, reaching 5-7% dry substance (DS) (i.e., 50,000 to 70,000 mg/L) from a starting concentration of 1,000 to 2,000 mg/L. When the suspended solids are deposited as a cake layer 36 onto the first face 84 of the at least one liquid-permeable filtering element 40, the solids undergo a physical transformation, changing from a fluid floc suspended in wastewater to a gelatinous solid. Typical cake layer 36 concentrations range from 2-5% DS (dry solids, substance), which may be readily removed from the at least one liquid-permeable filtering element 40. The thicker the cake layer 36 is that forms on the first face 84 of the liquid-permeable filtering element 40, the lower the amount of total suspended solids present in the filtrate 105. For example, a cake layer 36 of sufficient thickness on the first face 84 of the liquid-permeable filtering element 40 may produce a filtrate 105 having a TSS content of less than 10 mg/L, such as less than 5 mg/L. The filtrate 105 that leaves the filter 104 is suitable for polishing.

The at least one liquid-permeable filtering element 40 may be sprayed with a liquid, such as a filtrate 105, to remove or aid in the removal of a cake layer 36 from the first face 84 of the at least one liquid-permeable filtering element 40 that forms from the deposition of suspended solids onto the first face 84 of the at least one liquid-permeable filtering element 40.

For example, referring to FIG. 5, the filter 104 may include at least one nozzle that is configured to shoot a jet or stream of fluid in the direction of the at least one liquid-permeable filtering element 40. For example, the filter 104 may comprise a first nozzle 48 that shoots a jet or stream 50 of fluid at the second face 86 of the liquid permeable filtering element 40, through the liquid permeable filtering element 40, and towards the first face 84 of the at least one liquid-permeable filtering element 40 to remove and/or aid in the removal of the cake layer 36 formed on the first face 84 of the at least one liquid-permeable filtering element 40. The jet or stream 50 of fluid may form a slip layer 46 between the at least one liquid-permeable filtering element 40 and cake layer 36. The filter 104 may comprise a second nozzle 52 that shoots a jet or stream 54 of fluid at the first face 84 of the liquid-permeable filtering element 40. The fluid provided by the first and/or second 48, 52 nozzle(s) may be any liquid known in the art. For example, said fluid provided by the first and/or second nozzle 48, 52 may be a liquid, such as a portion of the filtrate 105. Alternatively, said fluid provided by the first and/or second nozzle 48, 52 may be a gas.

In the case of a non-limiting rotating filter 104, said FTM may rotate at 0.3 to 1 rpm, or up to 2 rpm, such as to additionally aid in the deposition of the suspended solids on the liquid-permeable filtering element 40 of the FTM. The cake layer 36 may be deposited, grown, and thickened in the time of one revolution of the FTM.

The at least one liquid-permeable filtering element 40 of the filter 104 removes the suspended solids from the filterable water 112, thus producing a clear, liquid filtrate 105. The cake layer 36 remains on the first face 84 of the at least one liquid-permeable filtering element 40 until removed.

Alternative filtering methods provide excessive mixing, excessive retention times, and changes in temperature and pH that will negatively affect the floc stability. The decreased floc stability will allow for the suspended solids to deteriorate, decreasing its size, and preventing it from being properly filtered and deposited on the first face 84 of the at least one liquid-permeable filtering element 40, thereby decreasing the filtrate 105 quality.

The at least one liquid-permeable filtering element 40 may have a specified pore size. For example, the pore size of the at least one liquid-permeable filtering element 40 may be in the range of from 2 to 40 μm, such as 2 to 30 μm, such as less than 20 μm.

The at least one liquid-permeable filtering element 40 operates within the filterable water 112, aided by aerators 108 which are used to maintain suspended solids in the filterable water 112. The filterable water 112 travels through the cake layer 36 and the liquid-permeable filtering element 40, and collecting on the opposite side of the liquid-permeable filtering element 40 as a filtrate 105 where it may then be transferred to external to the filter 104. If the at least one liquid-permeable filtering element 40 is in the shape of a disc or a drum, as shown in FIGS. 6-7, the filtrate 105 may be removed from the filter 104 via an opening 56 positioned coaxially to the disc or drum 40. The cake layer 36 that is deposited on the first face 84 of the liquid-permeable filtering element 40 of the filter 104 may be removed by back-wetting the second face 86 of the liquid-permeable filtering element 40 to generate a slip layer 46 between the cake layer 36 and the liquid-permeable filtering element 40. For example, water, such as the filtrate 105, may be applied from a first nozzle 48 to the second face 86 of the at least one liquid-permeable filtering element 40, such that the liquid goes through the at least one liquid-permeable filtering element 40 and towards the first face 84 of the at least one liquid-permeable filtering element to form a slip layer 46 between the first face 84 of the at least one liquid-permeable filtering element 40 and the cake layer 36, thereby allowing the cake layer 36 to be more readily removed from the first face 84 of the liquid-permeable filtering element 40.

The cake layer 36 may then be removed from the first face 84 of the liquid-permeable filtering element 40 and returned into the filterable water 112 where said cake layer 36 combines with a small amount of the filterable water 112 to produce a sludge 7 and will settle to the bottom in a sludge outlet 11.

The filter 104 may have a flowrate of at least 2,000 L/h per m² of filter area, such as at least 2,500 L/h per m² of filter area, such as at least 3,000 L/h per m² of filter area, such as at least 3,500 L/h per m² of filter area. The filter 104 may operate at any TSS content in the filterable water 112; however, in order to achieve a flow rate of at least 2,000 L/h per m² of filter area, the total suspended solids must be less than 5 g/L, which is accomplished by consuming at least 75% of the mass of contaminants in the filterable water 112, which is achievable via the biofilm supporting media 9 present in the bioreactor. Additionally, by implementing biofilm supporting media 9 in the bioreactor as discussed above, the present methods and/or systems can achieve a flowrate of at least 2,000 L/h per m² of filter area, such as at least 2,500 L/h per m² of filter area, such as at least 3,000 L/h per m² of filter area, such as at least 3,500 L/h per m² of filter area using only one filter 104, which is not achievable using one filter in existing systems, which saves costs and space. The bioreactors of the present invention may have a peak flowrate that is 3.5 times greater than the average daily flowrate of a bioreactor.

For example, the FTM of PCT Application Number PCT/EP2019/074913 may be implemented at said TSS content levels. Referring to FIGS. 2A-8, the filter 4, 104 of the present invention may operate the same, or substantially the same, as the FTM of PCT/EP2019/074913. For example, the FTM may comprise at least one liquid-permeable filtering element 40 that includes a first face 84 and a second face 86 opposite of the first face 84. The cake layer 36 that forms from the filtering of the filterable water 112 may form on the first face 84 of the at least one liquid-permeable filtering element 40. The filterable water 112 may deliberately foul the at least one liquid-permeable filtering element 40, thereby forming the cake layer 36 on the first face 84 of the at least one liquid-permeable filtering element 40 and also a filtrate 105 which passes through the at least one liquid-permeable filtering element 40. A liquid, such as the filtrate 105, may be sprayed at the at least one liquid-permeable filtering element 40 to remove and/or aid in the removal of the cake layer 36 from the first face 84 of the liquid-permeable filtering element 40. For example, a first nozzle 48 may spray a jet or stream 50 of fluid at the second face 86 of the at least one liquid-permeable filtering element 40. A second nozzle 52 may spray a jet or stream 54 of fluid at the first face 84 of the at least one liquid-permeable filtering element 40. For example, said fluid provided by the first and/or second nozzle 48, 52 may be a liquid, such as a portion of the filtrate 105. Alternatively, said fluid provided by the first and/or second nozzle 48, 52 may be a gas. A portion of the first face 84 of the at least one liquid-permeable filtering element 40 may be subject to the filterable water 112 under pressure where the pressure across said portion of the first face 84 is greater than 0 and less than or equal to 5.9 kPa when the at least one liquid-permeable filtering element 40 is in a first position which is at least partially submerged in the filterable water 112. In a second position, wherein the at least one liquid-permeable filtering element 40 is no longer submerged in the filterable water 112, the first face 84 of the at least one liquid-permeable filtering element 40 is not subject to filterable water 112 under pressure or is subject to filterable water 112 at a lower pressure than in the first position. The FTM may include at least one nozzle 48 that directs at least one jet or stream 50 of fluid at the second face 86 of the at least one liquid-permeable filtering element 40, through the at least one liquid-permeable filtering element 40, and towards the first face 84 of the at least one liquid-permeable filtering element 40 to remove and/or aid in the removal of the cake layer 36. A second nozzle 52 may spray a jet or stream 54 of fluid at the first face 84 of the at least one liquid-permeable filtering element 40. For example, said fluid provided by the first and/or second nozzle 48, 52 may be a liquid, such as a portion of the filtrate 105. Alternatively, said fluid provided by the first and/or second nozzle 48, 52 may be a gas. Software and physical performance enhancers may also be implemented to increase the efficiency of the filter 104. For example, the speed of rotation of the at least one liquid-permeable filtering element 40, intensity of aerator(s) 108, and the back-wetting parameters are operated at lower intensity, compared to the biological treatment process of the FTM in PCT/EP2019/074913.

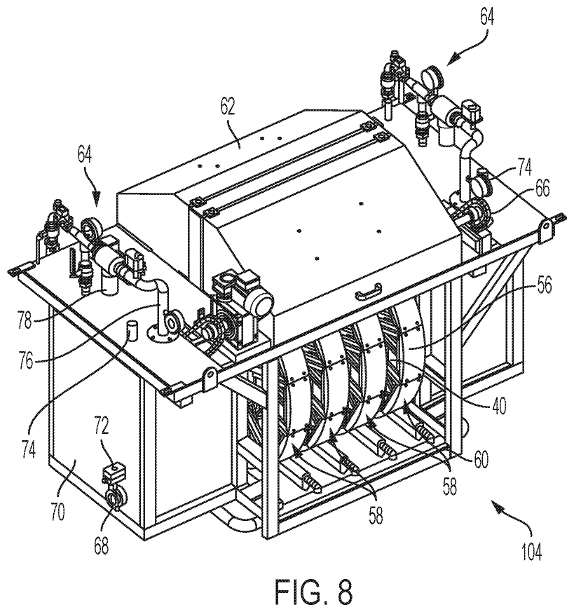

The filter 4 may be the filter 104 of FIG. 8, such as one of the various filters described in PCT/EP2019/074913. It is noted that the filter 104 is shown without a container 22, which has been removed for clarity purposes. The filter 104 may comprise a disc structure 56. The disc structure 56 may comprise at least one disc 58, such as a plurality of discs 58. Each disc 58 comprises at least one liquid-permeable filtering element 40, such as a plurality of liquid-permeable filtering elements 40. The disc(s) 58 take the form of a circular ring with an inside radius and an outside radius. The number of disc(s) 58 in the disc structure 56 may be from 1 to 40, such as from 2 to 40, and an outer diameter from 0.5 m to 4 m. The filter 104 may be positioned rotatably inside a frame 60, such that the disc structure 56 may rotate along a center axis. The filter 104 may comprise a cover 62 over top of the disc structure 56. The rotation of the disc structure 56 may be enabled by the gearboxes and transmission shaft 66. The cover 62 may include hatches such that the cover can be opened to view the disc structure 56. The filter 104 may comprise at least one water supply system 64, such as at least two water supply systems 64. The water supply systems 64 may supply a fluid, such as a portion of the filtrate 105, to nozzles 48, 52 (see FIG. 5) to be sprayed at the at least one liquid-permeable filtering element 40. The at least one water supply system 64 may comprise at least one pump 78 and at least one pipe 76 that transfers filtrate 105 from the filtrate tank 70 to the nozzles 48, 52 to be sprayed at the at least one liquid-permeable filtering element 40 to aid in the removal of the cake layer 36. Alternatively, said fluid provided by the first and/or second nozzle 48, 52 may be a gas. The filter 104 may comprise a filtrate outflow pipe 68 that the filtrate 105 travels through to exit the filter 104 and is connected upstream to a filtrate tank 70 which contains the filtrate 105 before it is removed from the filter 104. At least one motorized valve 72 may be provided to open and close the filtrate outflow pipe 68. The filter 104 may comprise at least one turbidity sensor 74 to verify the turbidity of the filtrate 105 contained in the filtrate tank 70. It is noted that each component of the water supply system 64 and the filtrate tank 70 may be provided on both sides of the filter 104, such that two water supply systems 64 are provided, one on each side of the filter 104, such that filtrate 105 may be removed and/or cycled through the water supply system(s) 64 on both sides of the filter 104.

The at least one liquid-permeable filtering element 40 of the filter 104 may have an optimized pore size, such as a pore size in the range of 2 to 40 μm. The filter 104 may consume from 0.02 to 0.04 kilowatt hours per meter cubed of filtrate 105 processed (kWh/m³), while known filtration devices and processes operate at 0.15 to 0.25 kWh/m³.

As previously stated, the cake layer 36, formed from the suspended solids that were suspended in the filterable water 112 prior to filtering, is removed from the first face 84 of the at least one liquid-permeable filtering element 40 and reintroduced into the filterable water 112. When reintroduced into the filterable water 112, the cake layer 36 will combine with a small amount of wastewater of the filterable water 112 to form a sludge 7 and will sink to bottom of the container 22 to the sludge outlet 11. For example, back-washing of the at least one liquid-permeable filtering element 40 may aid in the removal of the cake layer 36, by applying a jet or stream 50 of a fluid to the second face 86 of the at least one liquid-permeable filtering element 40 from a nozzle 48, thereby penetrating the at least one liquid-permeable filtering element 40 and generating a slip layer 46 between the cake layer 36 and the first face 84 of the at least one liquid-permeable filtering element 40. Alternatively, the nozzle 48 may apply a jet or stream 50 of gas to the second face 86 of the at least one liquid-permeable filtering element 40. Once the cake layer 36 is separated from the first face 84 of the at least one liquid-permeable filtering element 40, gravity reintroduces the cake layer 36 into the filterable water 112 and the sludge 7 falls to the sludge outlet 11. As the cake layer 36 falls through the filterable water 112, the cake layer 36 is combined with a small amount of filterable water 112, thereby producing a sludge 7. For example, by the time the cake layer 36, that has been removed from the first face 84 of the at least one liquid-permeable filtering element 40, reaches the sludge outlet 11, the cake layer 36 will have been combined with enough filterable water 112 to produce a sludge 7. The sludge 7 may be removed from the sludge outlet 11 using a transportation apparatus. For example, the sludge 7 may be removed from the sludge outlet 11 by pumping the sludge 7 with a pump through pipe(s) to, for example, a waste to energy system. Alternatively, a height difference between the level 28 of the filterable water 112 in the container 22 of the filter 104 and the sludge 7 in the waste to energy system may cause gravity to transport the sludge 7 from the sludge outlet 11 to external to the filter 104, such as to a waste to energy system. The filtrate 105 may also be removed from the filter 104 with a transportation apparatus. The transportation apparatus that transports the filtrate 105 out of the filter 104 may include a pump that pumps the filtrate 105 through pipe(s) to external to the filter 104.

The cake layer 36 that is removed from the first face 84 of the at least one liquid-permeable filtering element 40 falls into the filterable water 112, where said cake layer 36 combines with a small amount of filterable water 112 to produce a sludge 7, and then said sludge 7 continues to sink until it is accumulated in the sludge outlet 11. The sludge 7 may be suitable as a source of fuel for an energy process. The concentration of TSS in the filterable water 112 may be between 2% DS and 5% DS (20,000 to 50,000 mg/L) and may be a concentration suitable for a waste to energy process and/or plant. As used herein, “waste to energy” refers to a process or a system that takes a contaminated liquid and processes said liquid to produce a substance that can be used as a source of energy. The sludge 7 removed from the sludge outlet 11 of the filter 104 may have a calorific value in the range of 18 and 25 MJ/kg of dry substance which is above the calorific value of the known activated sludge processes, which typically ranges from 12-15 MJ/kg of dry substance. Thus, the present process may generate more biogas from an enriched carbon source than known processes in the art.

The sludge 7, having a TSS content of from 10,000-50,000 mg/L, is extracted from the sludge outlet 11 at the bottom of the container 22 of the filter 104. The hydraulic retention time of the filterable water 112, in the container 22 of the filter 104, may be from 5 minutes to 30 minutes. This retention time of the filterable water 112 in the container 22 of the filter 104 is such so as to avoid floc deterioration or the onset of any biological reactions from bacteria that enters the system. At TSS levels in the sludge 7 above 8,000 mg/L suppresses the foaming nature of the suspension. Air mixing from the at least one aerator 108 may be used to aid in the avoidance of foaming. The sludge 7 may have a TSS content of at least 10,000 mg/L, or at least 12,000 mg/L, or at least 15,000 mg/L. The sludge 7 may have a TSS content of up to 70,000 mg/L, or up to 60,000 mg/L, or up to 50,000 mg/L, or up to 25,000 mg/L. The TSS content of the sludge 7 and/or the filterable water 112 may be continuously monitored so that the rate of filtering may be controlled to maintain a TSS content in the sludge 7, such as to maintain a TSS content in the sludge 7 of at least 10,000 mg/L.

Once the sludge 7 is transported external to the filter 104, the sludge 7 may be used in a number of different processes. For example, the sludge 7 may be used in a waste to energy process and/or system, where the sludge 7 is used as a fuel source. For example, the sludge 7 may be a renewable fuel source. As used herein, a “renewable” fuel source refers to a non-finite and non-exhaustible fuel source, such that it may be replenished in a finite amount of time on a human time scale. The waste to energy process and/or system may produce 0.4 to 0.5 kWhr/m³ of energy. Various non-limiting examples of waste to energy processes and/or systems that may use the sludge 7 as a fuel source include anaerobic digestion (AD) and enhanced AD, pyrolysis, thermal oxidation, bioelectric fuel cell conversion, and the like.

At least a portion of the sludge 7 may be transferred from the filtration zone 6 and/or sludge outlet 11 to the inlet zone 2, which is represented in FIGS. 2A-4B by the bolded arrow spanning from the filtration zone 6 and sludge outlet 11 to the inlet zone 2. At least a portion of the sludge 7 may be transferred to the inlet zone 2 to increase the total suspended solids of the wastewater 1 at the inlet zone 2. For example, at least a portion of the sludge 7 may be transferred to the inlet zone 2 by pumping the sludge 7 from the filtration zone 6 and/or sludge outlet 11 to the inlet zone 2. At least a portion of the sludge 7 may be transferred, such as pumped, from the filtration zone 6 and/or sludge outlet 11 to the inlet zone 2 in a transfer pipe. During transfer of the sludge 7 in the transfer pipe, the sludge 7 may be actively mixed with at least a portion of the wastewater 1 and/or filterable water 12, 112. Alternatively, no sludge 7 is transferred from the filtration zone 6 and/or sludge outlet 11 to the inlet zone 2.

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment. The embodiments of the invention described herein above in the context of the preferred embodiments are not to be taken as limiting the embodiments of the invention to all of the provided details thereof, since modification and variations thereof may be made without departing from the spirit and scope of the embodiments of the invention.

1. A method for removing contaminants from wastewater to produce a filtrate and a sludge: the steps comprising:
providing a bioreactor comprising:
an inlet zone for receiving wastewater,
a filtration zone comprising a filter; and
a reaction zone between the inlet zone and the filtration zone comprising:
a biofilm supporting media comprising a biofilm of biofilm forming bacteria thereon, wherein the biofilm supporting media is provided in a sufficient quantity to enable the biofilm forming bacteria thereon to consume at least a portion of the contaminants from the wastewater to produce filterable water that has a total suspended solids of less than 5 g/L at the filtration zone; and
water comprising suspended bacteria; and
introducing wastewater comprising contaminants to the inlet zone of the bioreactor;
providing anoxic and/or aerobic conditions in the reaction zone of the bioreactor to cause the consumption of the contaminants by the biofilm forming bacteria on the biofilm supporting media and the suspended bacteria contained in the water to produce filterable water; and
filtering the filterable water at the filtration zone to produce a filtrate and a sludge, wherein the filtrate has total suspended solids of less than 10 mg/L with a flowrate of at least 2,000 L/h per m² of filter area.

2. The method of claim 1, wherein the biofilm forming bacteria consumes at least 75% by mass of the contaminants.

3. The method of claim 1, further comprising transferring at least a portion of the sludge external of the bioreactor.

4. The method of claim 1, further comprising transferring at least a portion of the sludge to the inlet zone.

5. The method of claim 4, wherein the transferring at least a portion of the sludge to the inlet zone step further comprises actively mixing the sludge with the wastewater and/or filterable water in a transfer pipe.

6. The method of claim 1, further comprising aerating the water in the reaction zone such that the water comprises less than 5,000 mg/L of total suspended solids.

7. The method of claim 1, further comprising discharging excess biofilm forming bacteria on the biofilm supporting media into the water.

8. The method of claim 7, further comprising aerating the biofilm supporting media to discharge excess biofilm forming bacteria on the biofilm supporting media into the water.

9. The method of claim 1, wherein the bioreactor comprises a plurality of biofilm supporting media.

10. The method of claim 9, wherein the inlet zone, filtration zone, and/or the reaction zone of the bioreactor comprises the plurality of biofilm supporting media.

11. The method of claim 1, wherein the biofilm supporting media comprises a fixed media.

12. The method of claim 1, wherein the biofilm supporting media comprises a suspended media.

13. The method claim 12, wherein the suspended media comprises a sponge comprising polyurethane.

14. The method of claim 1, wherein the biofilm forming bacteria of the biofilm supporting media consumes the contaminants at a rate of at least 0.4 kg BOD/m²/day.

15. The method of claim 1, wherein the biofilm forming bacteria has a longer mean cell residence time than the suspended bacteria.

16. The method of claim 1, wherein the filter comprises a permeable substrate, and further comprising: deliberately fouling the permeable substrate to form a layer of deposited solids from the filterable water on the permeable substrate, removing at least a portion of the layer, and mixing the removed portion of the layer with at least a portion of the filterable water to form the sludge with the at least 10,000 mg/L of total suspended solids.

17. The method of claim 1, wherein a level of dissolved oxygen in the sludge is no more than 0.5 mg/L.

18. A wastewater treatment plant for processing wastewater, comprising:
a bioreactor comprising:
an inlet zone for receiving wastewater,
a filtration zone comprising a filter for producing a filtrate and a sludge; and
a reaction zone between the inlet zone and the filtration zone comprising:
a biofilm supporting media comprising a biofilm of biofilm forming bacteria thereon, wherein the biofilm supporting media is provided in a sufficient quantity to enable the biofilm forming bacteria thereon to consume at least a portion of the contaminants from the wastewater to produce filterable water that has a total suspended solids of less than 5 g/L; and
water comprising suspended bacteria;
wherein the reaction zone comprises anoxic and/or aerobic conditions to cause consumption of the contaminants by the biofilm forming bacteria on the biofilm supporting media and the suspended bacteria contained in the water to produce the filterable water;
wherein the filter produces a filtrate and a sludge from the filterable water; and
wherein the filtrate has a total suspended solids of less than 10 mg/L with a flowrate of at least 2,000 L/h per m² of filter area.

19. The wastewater treatment plant of claim 18, wherein the biofilm supporting media comprises a fixed media.

20. The wastewater treatment plant of claim 18, wherein the biofilm supporting media comprises a suspended media.

21. The wastewater treatment plant of claim 18, wherein the biofilm forming bacteria of the biofilm supporting media consumes the contaminants at a rate of at least 0.4 kg BOD/m²/day.

22. The wastewater treatment plant of claim 18, further comprising a media screen in the reaction zone to prevent the biofilm supporting media from entering the filtration zone.
